(19) United States
(12) Patent Application Publication
(10) Pub. No.: US 2025/0265782 A1
(43) Pub. Date: Aug. 21, 2025

(54) SYSTEMS AND METHODS FOR DYNAMICALLY SYNCHRONIZING HAPTIC AND VISUAL SIMULATION DATA

(71) Applicant: FVRVS Limited, London (GB)

(72) Inventors: Pedro Mendes, London (GB); Victoria Jane Smalley, London (GB); Bruno Oliveira, London (GB)

(21) Appl. No.: 19/051,479

(22) Filed: Feb. 12, 2025

Related U.S. Application Data
(60) Provisional application No. 63/553,737, filed on Feb. 15, 2024.

(51) Int. Cl. G06T 17/20; G02B 27/01; G06F 3/01; G06V 20/52; G06V 40/20

(52) U.S. Cl. CPC G06T 17/20; G02B 27/017; G06F 3/014; G06F 3/016; G06V 20/52; G06V 40/28

(57) ABSTRACT

The present invention relates to systems, devices, and methods for providing a user with a more realistic and immersive extended reality (XR) simulation experience by dynamically synchronizing haptic feedback and visual feedback to be provided to the user via associated hand-held components and a wearable display.

### CROSS-REFERENCE TO RELATED APPLICATIONS

This application claims priority to, and the benefit of, U.S. Provisional Application No. 63/553,737, filed Feb. 15, 2024, the content of which is incorporated by reference herein in its entirety.

### FIELD OF THE INVENTION

The invention relates to systems and methods for providing extended reality (XR) simulations, and, more particularly, to systems and methods for providing a user with a more realistic XR simulation experience by dynamically synchronizing haptic feedback and visual feedback to be provided to the user via associated hand-held components and a wearable display.

### BACKGROUND

Extended reality (XR) refers to technologies combining real and virtual settings to produce engaging and immersive experiences. Virtual reality (VR), mixed reality (MR), augmented reality (AR), and cross reality are just a few of the technologies that fall under the umbrella of extended reality.

Extended reality environments have emerged in a variety of applications, including gaming, rehabilitation, medicine, biomedical instrumentations, robotics, sports, and simulated training experiences. Simulated training systems, including virtual reality (VR) mixed reality (MR) and/or augmented reality (AR) technologies, are advanced systems that can provide an immersive environment for precision skills transfer. For example, in the medical field, such technologies present the opportunity to provide a low-risk and cost effective means for surgical training. However, while high-quality VR and AR experiences and simulations are currently available, the application of such technologies in simulating high precision real-world scenarios remains a challenge. Specifically, current systems and the advanced technology required for them, have drawbacks preventing VR/AR platforms from being widely adopted. In particular, significant challenges relate to the realism and accuracy of the simulation.

In this developing field, adding haptic feedback to virtual experiences, such as surgical simulations, is another step towards more realistic virtual interactions. The implementation of haptic feedback technology, in addition to visual and auditory feedback, significantly enhances a user's immersive experience. Haptic technologies, for example, portable, wearable, or hand-held formats, aim to simulate tactile or kinesthetic interactions with a physical or virtual environment in order to enhance user experience and/or performance.

While haptic feedback can significantly enhance the immersive extended reality experience, integrating and implementing haptic feedback in a realistic manner remains challenging. Thus, there is a need for improved haptic feedback systems to address the shortcomings of current systems and to provide a realistic immersive experience in an extended reality environment.

### SUMMARY

The present invention recognizes the drawbacks of current XR systems that include kinesthetic haptic simulation, namely the technical challenges that limit the realism of the immersive experience in XR. In particular, the invention provides systems, devices, and methods that include an innovative haptic engine for providing realistic, immersive, haptic feedback seamlessly synchronized with visual XR content. The invention provides technological solutions to the complex problem of synchronizing haptic simulation with visual simulation in an extended reality and/or other spatial computing environment to provide a realistic, immersive XR experience. The systems of the invention provide a novel means of integrating and synchronizing the highly precise and computationally intensive haptic simulation with the immersivity, freedom, and high-quality rendering of a standalone VR/XR headset.

Haptic technologies aim to simulate tactile or kinesthetic interactions in a virtual environment in order to enhance the user extended reality experience. This is particularly important in simulated training systems that intend to provide an immersive testbed for the training and application of theoretical knowledge, precisions skills transfer, and to measure user performance.

One perceptual attribute that provides an essential basis for haptic-visual synchronization and/or integration is haptic delay. Haptic delay can be defined as the temporal difference between the actual haptic feedback and the expected one. Low latency, i.e. low haptic delay, in haptic simulation is necessary to achieve immersive results. Delayed haptic feedback can seriously disrupt many aspects of the interaction, such as the completion time and the quality of manipulation tasks, and the perception of physical properties in the virtual environment such as stiffness and friction.

Haptic delay is a result of the stringent computational and communication requirements associated with haptic data. To address haptic delay when providing a haptic kinesthetic XR simulation, conventional systems use a high-spec computer capable of simulating both the haptic content and rendering visual content on an XR display device, e.g. an XR headset. This is because the complex mathematical and physics calculations for haptic simulation must take place at a high frame rate with a low latency between the haptic device and the computer performing the calculations. Conventional systems can only achieve low latency via a wired connection between the haptic device and the simulation computer rendering the visual content of the haptic simulation to the XR display device. Thus, because of the stringent communication and computational needs, the quality of the user experience is drastically affected by delayed haptic feedback.

The invention solves these problems associated with conventional haptic simulations by providing a haptic engine capable of dynamically synchronizing haptic content with visual XR content, while achieving low latency, for example, a haptic latency of less than 1 millisecond. The invention provides novel systems, devices, and methods for providing highly precise and computationally expensive kinesthetic haptics simulations synchronized with the immersivity, freedom, and high rendering quality of a standalone XR/VR display, e.g. VR headset, without the need or expense of a high-spec computer. Thus, the systems, devices, and methods of the invention are hardware agnostic and are capable of interfacing with any haptic device and XR display or other spatial computing device for synchronization of haptic and visual simulation content for a realistic, immersive XR experience.

Aspects of the invention provide systems for providing an extended reality (XR) simulation. This system comprises a simulation platform configured to communicate and exchange data with one or more hand-held components and a wearable display for respectively providing an associated user with dynamically synchronized haptic feedback and visual feedback based on user interaction with a simulated environment.

In some embodiments, the simulation platform is configured to communicate and exchange data with the one or more hand-held components via a wired connection, and communicate and exchange data with the wearable display via a wireless connection. The simulated environment comprises one or more simulated objects, in some embodiments. Further, in some embodiments, the simulation platform is configured to monitor actions of the user to identify user interaction with one or more simulated objects within the simulated environment based on physical user interaction with the one or more hand-held components.

In some embodiments, the simulation platform comprises a hardware processor coupled to non-transitory, computer-readable memory encoded with a computer program that causes the processor to determine a type and a degree of haptic feedback to be provided to the user via the one or more hand-held components based on the user's physical interaction with the one or more hand-held components and the type of one or more simulated objects interacted with. The processor is configured to transmit one or more signals, via the wired connection, comprising haptic feedback simulation data to the one or more hand-held components to thereby cause the one or more hand-held components to provide the determined haptic feedback to the user, in some embodiments. For example, in some embodiments, a measured latency of transmission of the haptic feedback simulation data to the one or more hand-held components is less than 1 milliseconds. In some embodiments, haptic feedback provided to the user via the one or more hand-held components and associated visual feedback provided to the user via the wearable display have a latency of less than 1 milliseconds.

In some embodiments, the simulation platform comprises a hardware processor coupled to non-transitory, computer-readable memory encoded with a computer program that causes the processor to adjust output of digital content to be visually presented to the user via the wearable display based, at least in part, on the user's physical interaction with the one or more hand-held components. The processor is configured to transmit one or more signals, via the wireless connection, comprising visual simulation data to the wearable display to be rendered and visually presented to the user, in some embodiments. For example, the rendered visual digital content presented to the user via the wearable display mimics movement of the one or more simulated objects interacted with and based on the user's physical interaction with the one or more hand-held objects, in some embodiments. Further, the simulation platform further comprises a simulation engine configured to model the interactions using calculations associated with one or more algorithms comprising at least one of a position-based solver, a collision detection algorithm, a deformable mesh algorithm, and an adaptive mesh algorithm, in some embodiments.

In some embodiments, the visual simulation data is transmitted to the wearable display via a wireless communication protocol. For example, in some embodiments, the wireless communication protocol is a User Datagram Protocol (UDP) connection. Further, in some embodiments the visual simulation data comprises required data for visual simulation, wherein the required data for visual simulation is transmitted to the wearable display in each frame of the data transmission.

In some embodiments, the one or more hand-held components comprise kinesthetic haptic hardware. In some embodiments, the wearable display comprises an XR headset. For example, in some embodiments, the system is operable to run on wearable displays having different operating systems.

### BRIEF DESCRIPTION OF THE DRAWINGS

FIG. 1 illustrates a block diagram of systems of the invention according to one embodiment.

FIG. 2 is a block diagram illustrating one embodiment of a simulation platform of systems of the invention.

FIG. 3 illustrates a block diagram of a method for providing an XR simulation according to one embodiment of the invention.

### DETAILED DESCRIPTION

The present invention recognizes the drawbacks of current immersive reality systems, such as extended reality (XR) systems, that include kinesthetic haptic simulation. Namely, the systems, devices, and methods of the invention address the technical challenges that limit the realism of the immersive experience. More specifically, the invention provides systems, devices, and methods that include an innovative simulation platform which includes a haptic engine for providing realistic, immersive, haptic feedback seamlessly synchronized with visual XR content. The invention provides technological solutions to the complex problem of synchronizing haptic simulation with visual simulation in an extended reality and/or other spatial computing environment to provide a realistic, immersive simulation experience. The systems of the invention provide a novel way of integrating and synchronizing the highly precise and computationally expensive haptic simulation with the immersivity, freedom, and high-quality rendering of a standalone wearable display, such as a VR/XR headset.

### Overview

Haptic technologies aim to simulate tactile or kinesthetic interactions with a physical or virtual environment in order to enhance user experience and/or performance. Currently, to develop a haptic kinesthetic XR simulation or other spatial computing interaction with kinesthetic haptics, it is necessary to use a so-called high-spec or high-end computer that is able to simulate the haptics and render the realistic graphics on the display headset. In this context, high-spec refers to a performance computer equipped with the latest processors, fast graphics cards, large amounts of RAM and storage, and advanced cooling and power supplies. The main reason such computing power is necessary is that haptic simulation must be calculated at a high frame rate and with low latency between the haptic device and the computer performing the calculations.

Haptic delay, also referred to herein as haptic latency, haptic feedback latency, and latency, is a perceptual attribute that can drastically affect the quality of experience in many human-machine interaction scenarios such as in virtual reality and haptic-skill transfer applications. Haptic delay affects the synchronization of haptic and visual simulations. Haptic delay can be defined as the temporal difference between the actual haptic feedback and the expected one. Haptic delay is a result of the stringent computational and communication resources needed to synchronize haptic simulation with the visual simulation without a perceived latency.

Low latency in haptic feedback is essential to achieve immersive results in the integration of the haptic and visual simulations. In general, subjective user satisfaction drops as haptic delay increases. In particular, it is ideal to have the measured latency be 1 millisecond (ms) or less. With conventional systems and wireless protocols, the lowest achievable latency is typically about 6 ms of latency, which ultimately affects the realism of the haptic feedback. Thus, for haptic-visual integration with low latency, or low haptic delay, conventional systems require a wired connection between the haptic device and the simulation computer, which is used to render both the haptic simulation and the visual simulation to the wearable display, and to synchronize and integrate the haptic-visual simulation.

As disclosed herein, the current invention solves these haptic-visual integration and synchronization problems by providing systems that integrate haptic feedback with the visual content that achieve a haptic latency of about 1 ms or less, and without the need for either of a wired connection to the visual rendering engine and/or a high-spec computer. In particular, the invention provides systems, devices, and methods for synchronizing haptic feedback with visual content displayed on a wearable display, such as an XR headset or other spatial computing device, without the requirement for a wired connection and with a haptic feedback latency about 1 ms or less.

In general, realistic XR/VR/AR/MR experiences require processing large amounts of data quickly. As disclosed herein, the systems of the invention create a communication layer that converts the haptic device communication, calculates a haptic simulation, and synchronizes the haptic and visual interactions in the simulated environment to achieve simulations that represent real-world interactions. For example, the interactions may be the user interacting with a patient's tissue, and/or manipulating surgical tools or equipment. The systems of the invention provide for real-time synchronization of haptic feedback by moving the haptic simulation to be processed onto a low-spec and compact form factor computer.

Further, the invention accomplishes realistic, real-time, free-form interaction in a simulated immersive environment by combining simulation disciplines—physical, visual, audio, and haptic—in novel ways in a system encompassing a simulation platform capable of a new level of immersion. The system is built on improved techniques such as voxel representation, position-based dynamics, and solid constructive geometry to generate simulations that exhibit emergent properties and give infinite variability in outcome. As a result, the simulation experience is fluid and natural and in the direct control of the user. The synchronization of visual and haptic algorithmic rendering and audio integration represent unconventional data processing and manipulation steps that achieve improved realism in the immersive environment.

### Systems for Synchronizing Haptic-Visual Simulation Data

The invention includes systems for providing an immersive simulation experience. For example, aspects of the invention provide systems for providing an extended reality (XR) simulation. As used herein, extended reality (XR) refers to technologies combining real and virtual settings to produce engaging and immersive experiences. Virtual reality (VR), augmented reality (AR) and mixed reality (MR) are just a few of the technologies that may fall under the umbrella term of XR. The simulation may be any simulated environment. In non-limiting examples, the simulation may be one or more of an extended reality (XR), a virtual reality (VR), a mixed reality (MR), an augmented reality (AR), a cross reality, a cinematic virtual reality, and/or a spatial computing environment. The systems of the invention may be integrated with a platform that combines visual, audible and haptic capabilities in an immersive XR environment for teaching and assessing skills, with particular focus on precision skills transfer. For example, the systems of the invention may be integrated in a surgical simulation platform.

The systems described herein are configured to provide a realistic immersive experience that includes a realistic level of visual, and/or auditory, and kinesthetic/tactile data (detail) that is presented without processing delay such that the interaction is seamless to the user. The architecture of systems of the invention include a simulation platform, which may include a haptic engine and a simulation engine. The simulation platform is configured to communicate and exchange data with one or more hand-held components, i.e. haptic device, and one or more wearable displays, i.e. an XR headset, for respectively providing an associated user with dynamically synchronized haptic feedback and visual feedback based on user interaction with a simulated environment.

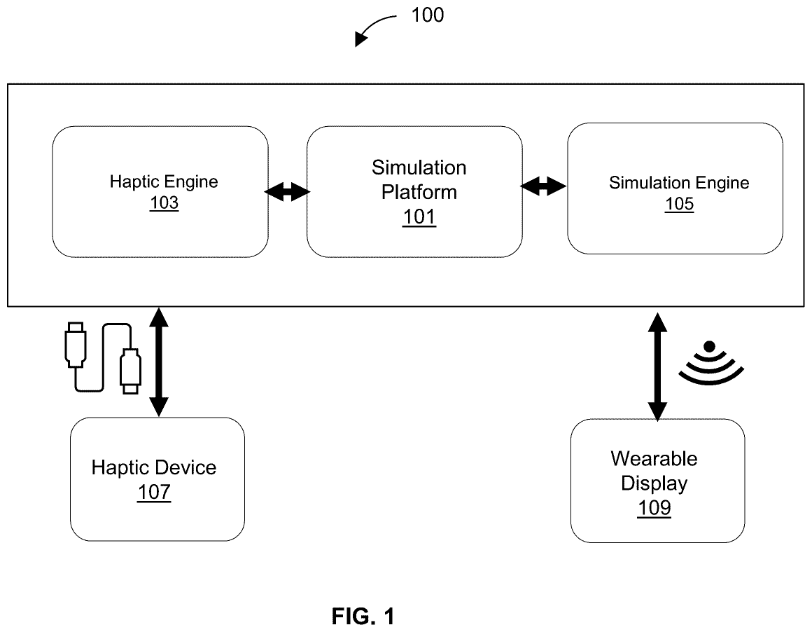

FIG. 1 illustrates a block diagram of systems of the invention according to one embodiment. The system 100 includes a simulation platform 101. The simulation platform 101 may include a haptic engine 103 and a simulation engine 105. The system communicates with and exchanges data with one or more haptic devices 107 and one or more wearable displays 109 to provide an associated user with dynamically synchronized haptic feedback and visual feedback based on user interaction with a simulated environment.

As disclosed in more detail herein, in some embodiments, the simulated environment may include one or more simulated objects. Accordingly, the simulation platform 101 may be configured to monitor actions of the user to identify user interaction with one or more of the simulated objects within the simulated environment based on physical user interaction with the one or more hand-held components, i.e. haptic device 107. In some embodiments, the simulation platform may be configured to determine a type and a degree of haptic feedback to be provided to one or more users via an associated hand-held component based on a user's physical interaction with an associated hand-held component and the type of simulated object. The simulation platform may be configured to adjust output of digital content to thereby mimic operation and/or movement of the simulated object.

The simulation platform 101 may include a haptic engine 103 that uses an algorithmic approach to haptic tool action and programming, allowing for rapid development of tool/object haptic interaction. As used herein, a haptic tool may be any simulated object that can affect a haptic response on a secondary simulated item (haptic target). The haptic target may be any simulated item that can be affected by a haptic tool. A haptic action may be the interaction between a haptic tool and a haptic target, often when a force is applied.

Haptic systems may provide both kinesthetic feedback, i.e. feedback simulating the weight or pressure of an object, or tactile feedback which simulates texture. The haptic simulation is processed using the haptic engine 103, which is provided on a separate computing device than the simulation engine. For example, the haptic simulation may be processed on a low-spec and compact form factor computer such as a Raspberry PI. By low-spec, the computer may be an economical computer, for example a non-gaming computer without a dedicated graphics card. The haptic engine may be connected to the haptic device, in some embodiments, for example via a wired or wireless connection. Alternatively, the haptic engine may be embedded into the haptic device. Thus, the disclosed systems include providing the haptic engine on a separate computing device connected to the haptic device and/or embedded into the haptic device.

By providing the haptic engine on a separate computing device, the simulation platform calculates the haptic simulation at a high frame rate and a low latency between the haptic engine and the haptic device. For example, the latency between transmission of the haptic feedback simulation from the simulation platform to the haptic device may be less than 6 milliseconds. In some embodiments, the measured latency of transmission of the haptic feedback simulation data to the one or more hand-held components may be less than 1 milliseconds. In some embodiments, the haptic feedback provided to the user via the one or more hand-held components and associated visual feedback provided to the user via the wearable display have a latency of less than 1 milliseconds.

In some embodiments, the simulation platform may be configured to communicate and exchange data with the one or more hand-held components via a wired connection, and to communicate and exchange data with the wearable display via a wireless connection. Thus, in some embodiments, the haptic engine 103 may be connected to the haptic device 107 through a wired connection, such as via a USB connection. In some embodiments, the haptic engine 103 may be integrated into the haptic device 107 as part of the haptic device.

In some embodiments, the simulation platform includes a hardware processor coupled to non-transitory, computer-readable memory encoded with a computer program that causes the processor to determine a type and a degree of haptic feedback to be provided to the user via the one or more hand-held components based on the user's physical interaction with the one or more hand-held components and the type of one or more simulated objects interacted with. In some embodiments, the processor is configured to transmit one or more signals, via the wired connection, comprising haptic feedback simulation data to the one or more hand-held components to thereby cause the one or more hand-held components to provide the determined haptic feedback to the user.

The system, via the simulation platform and/or haptic engine, may perform the complex mathematical and physics calculations to generate the haptic simulation. For example, the system may use algorithmic calculations to determine a type and degree of haptic feedback, i.e. a haptic value, based on properties of the simulated object and the haptic tool. This haptic value may be used to transmit haptic feedback to the hand-held device. Thus, the systems of the invention do not specifically program the combination of each type of interaction on a case-by-case basis, and are not limited to pre-determined interactions. A simulated object may be displayed and the movement of the haptic tool may be moved based on a user's movement of a hand-held device. Moreover, the visual feedback may also be algorithmically configured to be displayed in accordance with the type of interaction. This approach to achieving unique, free-form interactions of each haptic tool with haptic targets such as tissues or substances is made possible by defining a limited number of possible affordances that a haptic tool can implement along with a matching number of possible susceptibilities that a haptic target can respond to. These affordances and susceptibilities are each assigned a numerical value which are then combined to establish the nature of the interaction between the haptic tools and haptic targets.

For example, tools may have a defined sharpness affordance and targets may have a defined sharpness susceptibility, such that these values may be combined algorithmically and translated into actions and effects in the simulation. This creates an abstraction layer between a tool and its affordances, and a target and its susceptibilities, which enables the systematic and generalizable calculation of effects generated. As a result, complexity and effort are proportional to the number of affordances and susceptibilities of the tools and targets of the simulation, which allows the systems of the invention to store data related to the virtual/augmented/cross-reality experience in a highly efficient manner. This allows for the handling of interactions between tools and targets to be conducted through an abstraction layer, which radically reduces the amount of programming effort needed to support the required tools and targets needed to fulfil the simulation.

Further, systems of the invention may utilize high frequency haptic surface data, a mechanism for creating high volumes of haptic information via the use of 2-dimensional (2D) UV coordinates. The standard approach to defining the shape of an object in 3D simulations using haptics is use polygons as an easily computable approximation. By definition these polygons are flat and contain no surface detail of any kind. In order to increase the level of detail of the haptic shape it is necessary to increase the number of polygons and consequently the load on the processor in terms of vertex data processing and collision detection. Humans may be able to detect variation in surface texture with sub micro-meter accuracy. As a result, modelling objects in the simulation at this level of detail quickly reaches a limit above which an acceptable frame-rate cannot be maintained and is therefore not possible to deliver precise haptic reactions at a small scale using standard techniques.

Systems of the invention may add haptic detail to the flat surface of polygons via a two dimensional array of height offsets which can be easily authored as a grey-scale image using commonly available graphics tools. In standard graphics engines, polygons are defined by vertices. Each vertex contains its position in 3D space along with storage space for a two dimensional coordinate, referencing a point within an image, otherwise known as UV coordinates. With visual rendering the UV coordinates are used to enhance the appearance of the surface of the object.

The systems of the invention are configured to communicate with and interface with one or more haptic devices. The haptic device may be any haptic device. Systems of the invention may interface with, for example, force-based haptic devices, thermal based haptic devices, and nerve stimulation based haptic devices. The haptic device may be a hand-based device such as a glove or hand-held component, or wearable devices, such as fingertip, glove-based or exoskeleton devices, or handheld and/or tool-based devices. In non-limiting examples, the handheld component may be a wand, joystick, haptic glove, grasper, mouse or roller. In some embodiments, the one or more handheld components is kinesthetic haptic hardware.

The simulation platform communicates with the one or more haptic feedback devices through the manufacturer's API. The interface of the API may be adapted by the system so that communication with the simulation platform, and/or haptic engine, can take place. This allows for any haptic device to be connected to the systems of the invention. The system may be configured to run different operating systems and is capable of integrating with devices with different hardware requirements. Thus, the systems of the invention are device agnostic for both the haptic devices and the wearable displays.

The systems of the invention, via the algorithmic and physics calculations performed by the haptic engine and used to generate a haptic response, may simulate the complex multi-modal haptic stimuli experienced in the physical world by integrating kinesthetic and tactile perception with the visual immersive environment. Tactile perception relies on cutaneous receptors in the skin that perceive mechanical stimuli, such as high/low frequency vibrations, pressure and shear deformation, as well as electrical stimuli, temperature and chemicals. Cutaneous, or fingertip, haptic interfaces stimulate the user's skin at the fingertip to emulate the sensation of touching a real object by stimulating RA, SA1, and SA2 type mechanoreceptors. Kinesthetic haptic interfaces provide feedback in the form of force sensations that stimulate both mechanical stimuli as well as stimuli related to the position and movement of the body. Kinesthetic perception relies on sensory receptors in muscles, tendons, and joints that reflect the operational state of the human locomotor system, such as joint positions, limb alignment, body orientation and muscle tension. The systems of the invention support both cutaneous and kinesthetic haptics, in the form of multiple handheld devices and gloves. To recreate these extensive haptic experiences in a virtual setting requires complex technological solutions provided by systems of the invention.

Referring again to FIG. 1, the simulation platform 101 may include a simulation engine 105. The simulation engine 105 may include the digital content, information, and data for application execution and graphics processing for visually rendering the simulated immersive environment. The simulation engine may manage the 3D data and provide for rendering and texturing models, and loading and rendering the data to the wearable display. In some embodiments, the simulation engine is configured to model the interactions using calculations associated with one or more algorithms comprising at least one of a position-based solver, a collision detection algorithm, a deformable mesh algorithm, and an adaptive mesh algorithm.

The simulation engine 105 may be provided on a same or separate computing device than the haptics engine 103. In some embodiments, the simulation platform comprises a hardware processor coupled to non-transitory, computer-readable memory encoded with a computer program that causes the processor to adjust output of digital content to be visually presented to the user via the wearable display based, at least in part, on the user's physical interaction with the one or more hand-held components. In some embodiments, the processor is configured to transmit one or more signals, via the wireless connection, comprising visual simulation data to the wearable display to be rendered and visually presented to the user. In some embodiments, the rendered visual digital content presented to the user via the wearable display mimics movement of the one or more simulated objects interacted with and based on the user's physical interaction with the one or more hand-held objects.

The system and/or the simulation platform may be a web-based network server or web-based procedure platform. The simulation platform may be embodied on an internet-based computing system/service, such as a cloud based service. The system architecture of systems of the invention may be multi-tenant. The system and/or the simulation platform may be embodied on an internet-based computing system/service. The system architecture backend may be a cloud based service. The network may represent, for example, a private or non-private local area network (LAN), personal area network (PAN), storage area network (SAN), backbone network, global area network (GAN), wide area network (WAN), or collection of any such computer networks such as an intranet, extranet or the Internet (i.e., a global system of interconnected network upon which various applications or service run including, for example, the World Wide Web). In alternative embodiments, the communication path between the simulation platform and/or the handheld components, wearable displays, and the cloud-based service, may be, in whole or in part, a wired connection.

The network may be any network that carries data. Non-limiting examples of suitable networks that may be used as network include Wi-Fi wireless data communication technology, the internet, private networks, virtual private networks (VPN), public switch telephone networks (PSTN), integrated services digital networks (ISDN), digital subscriber link networks (DSL), various second generation (2G), third generation (3G), fourth generation (4G) cellular-based data communication technologies, fifth generation (5G) cellular-based data communication technologies, Bluetooth radio, Near Field Communication (NFC), the most recently published versions of IEEE 802.11 transmission protocol standards as of October 2018, other networks capable of carrying data, and combinations thereof. In some embodiments, network may be chosen from the internet, at least one wireless network, at least one cellular telephone network, and combinations thereof. As such, the network may include any number of additional devices, such as additional computers, routers, and switches, to facilitate communications. In some embodiments, the network may be or include a single network, and in other embodiments the network may be or include a collection of networks.

The systems of the invention provide a bridge between any kinesthetic haptic hardware and the XR visualization such that the immersive experience represents seamless, real-world interactions, for example, interactions such as the user interacting with a patient's tissue; and manipulating surgical tools or equipment. As disclosed herein, the simulation platform integrates the data from the haptic engine and the simulation engine to synchronize the haptic feedback with the interaction of the user within the immersive environment.

The simulation platform provides a communication layer between the haptic data and the graphic rendering data. The simulation platform integrates the data from the simulation engine with the complex mathematical and physics calculations of the haptic engine and provides only the essential haptic information back to the wearable display such that the simulation represents real-world interactions without perceived latency. The system, via the simulation platform, integrates the information/data from the haptic engine and communicates only the essential information to the wearable display. For example, in some embodiments, only the current states and poses of the simulation are communicated to the wearable display.

The essential data transmitted to the wearable display may include visual simulation data, such as pose and state data. The communication of the essential data to the wearable display may be achieved via a wireless communication protocol. The wireless communication protocol may be any protocol, for example, UDP, Wi-Fi, Bluetooth, Zigbee, Z-Wave, 6LoWPAN, RFID, cellular, LPWAN, NFC, LoRaWAN (Long Range Wide Area Network).

In some embodiments, the wireless communication protocol may be a User Datagram Protocol (UDP) connection. For example communication of the haptic data to the wearable display may be via a direct UDP connection over Wi-Fi, which allows for sending data at a fast rate. Thus the processor of the simulation platform may be configured to transmit to the wearable display, via the wireless connection, one or more signals comprising visual simulation data to be rendered and visually presented to the user.

UDP is a communications protocol primarily used to establish low-latency and loss-tolerating connections between applications. UDP speeds up transmissions because it uses a simple transmission model that doesn't include handshake dialogues to provide reliability, ordering or data integrity. Consequently, UDP may have an unreliable service. To promote lossless data transmission, the systems of the invention may be configured to manage the process of retransmitting lost packets and to correctly arrange received packets. Forward error-correction techniques may be used to improve simulation quality despite some loss. For example, systems of the invention provide for sending complete data in each frame. In this way, even if one packet is lost, it is possible to recover on the next frame. To ensure a minimum latency between the haptic device and the haptic simulation, no haptic information is communicated to the wearable device. Thus, in some embodiments, the visual simulation data comprises required data for visual simulation, wherein the required data for visual simulation is transmitted to the wearable display in each frame of the data transmission.

The systems of the invention provide a novel way of integrating and synchronizing the highly precise and computationally expensive haptic simulation with the immersivity, freedom, and high-quality rendering of a standalone wearable display, without the high cost of a high-spec computer.

The standalone wearable display may be any wearable display, as the systems of the invention are hardware agnostic and may be used with any wearable display. The system is operable to run on wearable displays having different operating systems. For example, the wearable display may be a VR headset such as the Apple Vision Pro or the Meta Quest 3. In non-limiting examples, the wearable display may be XR googles, an XR headset, or a VR, AR, or MR display. In some embodiments, the wearable display is an XR headset.

XR goggles are similar to headsets in that they involve the placing of graphics display surfaces in front of the eyes in order to render the views of a scene needed to simulate the depth of the simulated scene. The difference is that the goggles pass through the real world, overlaying the rendered image on top of the user's physical environment. This is done without digitally reproducing the world, as would be necessary with a full headset. Instead, the display surface is transparent, and if not displaying anything is essentially identical to wearing regular eyeglasses. When objects are drawn, they are drawn onto the goggles' lenses, either partially or completely blocking the physical environment from being seen through the obscured portion of the lens.

VR displays are designed to completely immerse the user in a virtual environment. They typically consist of a head-mounted display that covers the user's eyes and sometimes ears. VR displays use stereoscopic techniques to present separate images to each eye, creating a 3D effect.

AR displays overlay virtual content onto the real world, allowing users to interact with both simultaneously. AR displays can be categorized as an optical see-through display, which uses transparent screens or lenses to overlay virtual content onto the user's view of the real world, or a video see-through display, which uses cameras to capture the real-world view and then overlay virtual content onto the captured video feed.

Mixed Reality displays combine elements of both VR and AR, allowing users to interact with virtual content while maintaining awareness of the real world. Holographic displays create 3D images that appear to float in space without the need for special glasses or headsets. These displays use various techniques, such as interference patterns or light field displays, to create the illusion of depth and three-dimensionality.

Spatial computing is any of various human-computer interaction techniques that are perceived by users as taking place in the real world, in and around their natural bodies and physical environments, instead of constrained to and perceptually behind computer screens. Spatial computing devices rely on several technologies to mix the digital and physical worlds. The devices use computer vision, which processes data from cameras and other sensors and captures visual information about the environment, including the position, orientation, and movement of objects within the immersive environment. Spatial mapping is used to create a 3D model of the environment, which allows for more precise placement and manipulation of digital content.

Further, systems of the invention may use performant rendering of interior volumes of multi-part solids for seamless representation of dynamic object interaction and structures. Simulations must calculate and represent visual properties in milliseconds based on the user's actions. The systems of the invention may combine a voxel representation with a the use of texture atlasing, enabling significant improvement in performance and efficiency. The result is the seamless representation of dynamic object interaction with structures made up of many different textures and tissues, that is hardware agnostic.

Systems of the invention may use texture atlasing to tri-planar mapping, an approach to modelling 3-dimensional (3D) visual graphics which results in higher fidelity and lower latency of visual elements. Within the domain of 3D computer graphics, tri-planar visual texture mapping is the conventional way to texture the meshes created by various adaptive mesh algorithms (marching cubes/tetrahedrons etc.). It creates a near seamless surface by applying a texture using coordinates projected along three axes and blending them according to the vertex normals. However, representation of multiple material types is not well supported using this method, often leaving a less than ideal visual representation or a downturn in rendering speed, such that, as the user penetrates the virtual object, each visual effect needs to be programmed and rendered into the space. This results in a significant increase in code complexity and requires the creation of multiple meshes which in turn require multiple draw calls to be made, increasing processor load.

Systems of the invention are configured to represent multiple material types by using the otherwise unused texture coordinates (also known as UV coordinates) to represent an offset into a texture atlas comprised of multiple surface textures to depict various materials. Hence, unused UV coordinates are repurposed to refer to a texture atlas comprising the various material types, thereby providing an efficient and streamlined method of applying textures to a virtual object in real-time. For example, UV coordinates associated with voxels of a virtual object may be identified and then used to locate textures within the texture atlas using offset values based on the UV coordinates. Once located, the textures may be mapped onto the voxels of the virtual object. This provides a solution to the technical problem of generating a virtual environment with virtual objects that have multiple textures in real-time.

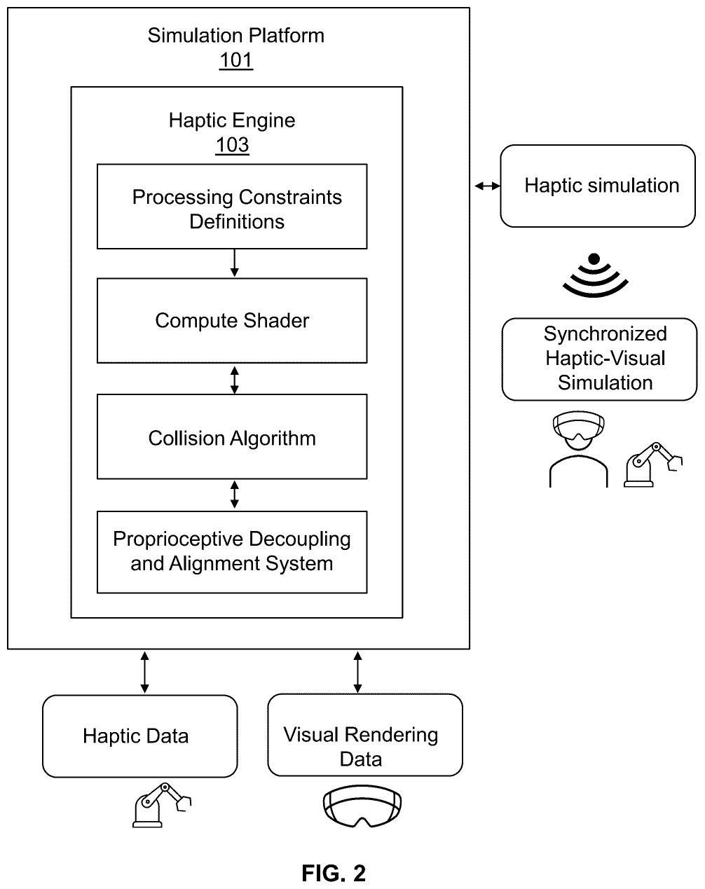

FIG. 2 is a block diagram illustrating one embodiment of a simulation platform 101 of a system 100 of the invention, and illustrating one embodiment of a haptic engine 103 of systems of the invention. Data from the one or more wearable display and data from the one or more haptic devices may be received by the simulation platform. As disclosed herein, the haptic engine may include unique algorithmic processing techniques for creating visual and haptic textures that provide a fully realistic immersive/simulated experience.

The haptic engine may include features that allow for haptics to be updated faster, such as ten times faster, than visuals to provide a realistic interaction with tissue types, for example in surgical simulations. For example, the haptic engine may include a system for defining processing constraints/rules, a compute shader to perform calculations, a collision algorithm, and a system for proprioceptive decoupling and alignment. As disclosed herein, the simulation engine and/or the haptic engine may be connected to the haptic device via a wired connection. The haptic engine and/or the simulation platform may be integrated into the haptic device. The system communicates with and exchanges data with one or more haptic devices and one or more wearable displays to provide an associated user with dynamically synchronized haptic feedback and visual feedback based on user interaction with a simulated environment. The haptic information is provided to the display device via a wireless connection.

As disclosed herein, in some embodiments, the simulated environment may include one or more simulated objects. Accordingly, the simulation platform 101 may be configured to monitor actions of the user to identify user interaction with one or more of the simulated objects within the simulated environment based on physical user interaction with the one or more hand-held components, i.e. haptic device.

The simulation platform may include one or more computing systems comprising a storage medium coupled to a processor that causes the processor to generate and provide digital content, as described above. As described herein, the simulation platform may dynamically adjust the generated digital content in response to data (feedback) received from the users and/or devices. The system may capture data from a variety of sensors associated with the user devices, for example, location of the user within the simulated environment, a point of gaze of the user within the simulated environment, a field of view of the user within the simulated environment, as well as a physical setting and objects within the environment. The sensors may include one or more of a camera, motion sensor, and global positioning satellite (GPS) sensor.

As noted, systems of the invention are software and hardware agnostic and the platform may be configured to interact without limitation with devices that may be embodied as a computer, a desktop computer, a personal computer (PC), a tablet computer, a laptop computer, a notebook computer, a mobile computing device, a smart phone, a cellular telephone, a handset, a messaging device, a work station, a distributed computing system, a multiprocessor system, a processor-based system, and/or any other computing device configured to store and access data, and/or to execute software and related applications consistent with the present disclosure.

The system may include a user interface or dashboard with which a user may interact. Users may interact with the user interface/dashboard via an associated device. For example, the system may include a web portal with which the user may interact with the dashboard/system via a mobile device, tablet, and/or desktop computer, such that the user interface may be embodied as a web application.

The systems of the present disclosure may include, in some embodiments, computer systems, computer operated methods, computer products, systems including computer-readable memory, systems including a processor and a tangible, non-transitory memory configured to communicate with the processor, the tangible, non-transitory memory having stored instructions that, in response to execution by the processor, cause the system to perform steps in accordance with the disclosed principles, systems including non-transitory computer-readable storage medium configured to store instructions that when executed cause a processor to follow a process in accordance with the disclosed principles, etc.

The processor(s) may be operably connected to the communication infrastructure and system architecture. The processor may be embodied as a single or multi-core processor(s), digital signal processor, microcontroller, or other processor or processing/controlling circuit.

The computing system further includes memory, such as random access memory (RAM), and may also include secondary memory. The memory may be embodied as any type of device or devices configured for short-term or long-term storage of data such as, for example, memory devices and circuits, memory cards, hard disk drives, solid-state drives, or other data storage devices. Similarly, the memory may be embodied as any type of volatile or non-volatile memory or data storage capable of performing the functions described herein.

Systems of the invention include and/or utilize one or more databases. In view of the disclosure provided herein, those of skill in the art will recognize that many databases are suitable for storage and retrieval of baseline datasets, files, file systems, objects, systems of objects, as well as data structures and other types of information described herein. In various embodiments, suitable databases include, by way of non-limiting examples, relational databases, non-relational databases, object oriented databases, object databases, entity-relationship model databases, associative databases, and XML databases. Further non-limiting examples include SQL, PostgreSQL, MySQL, Oracle, DB2, and Sybase. In some embodiments, a database may be internet-based. In further embodiments, a database may be web-based. In still further embodiments, a database may be cloud computing-based. In other embodiments, a database may be based on one or more local computer storage devices.

### Devices for Wireless Integration of Haptic-Visual Simulation

The invention includes devices for providing wireless haptic simulation data to a wearable display device and to integrate the haptic simulation with visual simulation in an immersive environment, such as an XR immersive environment. The devices of the invention may be integrated with a system that combines visual, audible and haptic capabilities in an immersive XR environment for teaching and assessing skills, with particular focus on precision skills transfer.

The devices described herein are configured to provide a realistic immersive experience that includes a realistic level of kinesthetic/tactile data (detail) that is presented without processing delay such that the integration with visual simulation provides a seamless interaction for the user. The devices of the invention may include a simulation platform, which may include a haptic engine and a simulation engine. The simulation platform may include both a haptic engine and a simulation engine. In embodiments, the simulation engine is separate from the simulation platform. The device is configured to communicate and exchange data with one or more hand-held components, i.e. haptic device, and one or more wearable displays, i.e. an XR headset, for respectively providing an associated user with dynamically synchronized haptic feedback and visual feedback based on user interaction with a simulated environment.

The simulated environment may include one or more simulated objects. Accordingly, the simulation platform may be configured to monitor actions of the user to identify user interaction with one or more of the simulated objects within the simulated environment based on physical user interaction with the one or more hand-held components, i.e. haptic device. The simulation platform may be configured to determine a type and a degree of haptic feedback to be provided to one or more users via an associated hand-held component based on a user's physical interaction with an associated hand-held component and the type of simulated object.

The simulation platform may be configured to be in communication with a separate simulation engine. The simulation engine may include the digital content, information, and data for application execution and graphics processing for visually rendering the simulated immersive environment. The simulation engine may manage the 3D data and provide for rendering and texturing models, and loading and rendering the data to the wearable display. Alternatively, the device may include a simulation engine. The simulation platform may be configured to adjust output of digital content to thereby mimic operation and/or movement of the simulated object.

The device may include a haptic engine that uses an algorithmic approach to haptic tool action and programming, allowing for rapid development of tool/object haptic interaction. As used herein, a haptic tool may be any simulated object that can affect a haptic response on a secondary simulated item (haptic target). The haptic target may be any simulated item that can be affected by a haptic tool. A haptic action may be the interaction between a haptic tool and a haptic target, often when a force is applied.

Haptic systems may provide both kinesthetic feedback, i.e. feedback simulating the weight or pressure of an object, or tactile feedback which simulates texture. The haptic simulation may be processed using the haptic engine, which may be provided on its own computing device. For example, the haptic simulation may be processed on a low-spec and compact form factor computer such as a Raspberry PI. By low-spec, the computer may be an economical computer, for example a non-gaming computer without a dedicated graphics card. The haptic engine may be connected to the haptic device, in some embodiments, for example via a wired or wireless connection. Alternatively, the haptic engine may be embedded into the haptic device. Thus, the disclosed systems and devices include providing the haptic engine on a separate computing device connected to the haptic device and/or embedded into the haptic device.

By providing the haptic engine on a separate computing device, the simulation platform calculates the haptic simulation at a high frame rate and a low latency between the haptic engine and the haptic device. In some embodiments, the measured latency of transmission of the haptic feedback simulation data to the one or more hand-held components may be less than 1 milliseconds. Additionally, the device is configured to transmit the haptic simulation to one or more wearable displays such that the haptic simulation and the visual simulation are seamlessly integrated and synchronized to provide a realistic immersive experience. In some embodiments, the haptic feedback provided to the user via the one or more hand-held components and associated visual feedback provided to the user via the wearable display have a latency of less than 1 milliseconds.

In some embodiments, the device may be configured to communicate and exchange data with one or more hand-held components via a wired connection, and to communicate and exchange data with one or more wearable displays via a wireless connection. Thus, in some embodiments, the device may be connected to the haptic device through a wired connection, such as via a USB connection. In some embodiments, the device may be integrated into the haptic device as part of the haptic device.

As disclosed herein, in some embodiments, the simulation platform includes a hardware processor coupled to non-transitory, computer-readable memory encoded with a computer program that causes the processor to determine a type and a degree of haptic feedback to be provided to the user via the one or more hand-held components based on the user's physical interaction with the one or more hand-held components and the type of one or more simulated objects interacted with. In some embodiments, the processor is configured to transmit one or more signals, via the wired connection, comprising haptic feedback simulation data to the one or more hand-held components to thereby cause the one or more hand-held components to provide the determined haptic feedback to the user.

The device, via the simulation platform and/or haptic engine, may perform the complex mathematical and physics calculations to generate the haptic simulation.

The devices of the invention are configured to communicate with and interface with one or more haptic devices. The haptic device may be any haptic device. Devices of the invention may interface with, for example, force-based haptic devices, thermal based haptic devices, and nerve stimulation based haptic devices. The haptic device may be a hand-based device such as a glove or hand-held component, or wearable devices, such as fingertip, glove-based or exoskeleton devices, or handheld and/or tool-based devices. In non-limiting examples, the handheld component may be a wand, joystick, haptic glove, grasper, mouse or roller. In some embodiments, the one or more handheld components is kinesthetic haptic hardware.

The devices of the invention, via the simulation platform, communicate with the one or more haptic feedback devices through the manufacturer's API. The interface of the API may be adapted by the device so that communication with the simulation platform, and/or haptic engine, can take place. This allows for any haptic device to be connected to the devices of the invention. The device may be configured to run different operating systems and is capable of integrating with devices with different hardware requirements. Thus, the devices of the invention are device agnostic for both the haptic devices and the wearable displays.

The devices of the invention, via the algorithmic and physics calculations performed by the haptic engine and used to generate a haptic response, may simulate the complex multi-modal haptic stimuli experienced in the physical world by integrating kinesthetic and tactile perception with the visual immersive environment. Tactile perception relies on cutaneous receptors in the skin that perceive mechanical stimuli, such as high/low frequency vibrations, pressure and shear deformation, as well as electrical stimuli, temperature and chemicals. Cutaneous, or fingertip, haptic interfaces stimulate the user's skin at the fingertip to emulate the sensation of touching a real object by stimulating RA, SA1, and SA2 type mechanoreceptors. Kinesthetic haptic interfaces provide feedback in the form of force sensations that stimulate both mechanical stimuli as well as stimuli related to the position and movement of the body. Kinesthetic perception relies on sensory receptors in muscles, tendons, and joints that reflect the operational state of the human locomotor system, such as joint positions, limb alignment, body orientation and muscle tension. The devices of the invention support both cutaneous and kinesthetic haptics, in the form of multiple handheld devices and gloves. To recreate these extensive haptic experiences in a virtual setting requires complex technological solutions provided by devices of the invention.

The simulation platform of the device may be include a simulation engine and/or may be in communication with a simulation engine. The simulation engine may include the digital content, information, and data for application execution and graphics processing for visually rendering the simulated immersive environment. The simulation engine may manage the 3D data and provide for rendering and texturing models, and loading and rendering the data to the wearable display. In some embodiments, the simulation engine may be configured to model the interactions using calculations associated with one or more algorithms comprising at least one of a position-based solver, a collision detection algorithm, a deformable mesh algorithm, and an adaptive mesh algorithm.

In some embodiments, the simulation platform comprises a hardware processor coupled to non-transitory, computer-readable memory encoded with a computer program that causes the processor to adjust output of digital content to be visually presented to the user via the wearable display based, at least in part, on the user's physical interaction with the one or more hand-held components. In some embodiments, the processor is configured to transmit one or more signals, via the wireless connection, comprising visual simulation data to the wearable display to be rendered and visually presented to the user. In some embodiments, the rendered visual digital content presented to the user via the wearable display mimics movement of the one or more simulated objects interacted with and based on the user's physical interaction with the one or more hand-held objects.

The simulation platform may be a web-based network server or web-based procedure platform. The simulation platform may be embodied on an internet-based computing system/service, such as a cloud based service. The system architecture of devices of the invention may be multi-tenant. The simulation platform of devices of the invention may be embodied on an internet-based computing system/service. The system architecture backend may be a cloud based service. The network may represent, for example, a private or non-private local area network (LAN), personal area network (PAN), storage area network (SAN), backbone network, global area network (GAN), wide area network (WAN), or collection of any such computer networks such as an intranet, extranet or the Internet (i.e., a global system of interconnected network upon which various applications or service run including, for example, the World Wide Web). In alternative embodiments, the communication path between the simulation platform and/or the handheld components, wearable displays, and the cloud-based service, may be, in whole or in part, a wired connection.

The network may be any network that carries data. Non-limiting examples of suitable networks that may be used as network include Wi-Fi wireless data communication technology, the internet, private networks, virtual private networks (VPN), public switch telephone networks (PSTN), integrated services digital networks (ISDN), digital subscriber link networks (DSL), various second generation (2G), third generation (3G), fourth generation (4G) cellular-based data communication technologies, fifth generation (5G) cellular-based data communication technologies, Bluetooth radio, Near Field Communication (NFC), the most recently published versions of IEEE 802.11 transmission protocol standards as of October 2018, other networks capable of carrying data, and combinations thereof. In some embodiments, network may be chosen from the internet, at least one wireless network, at least one cellular telephone network, and combinations thereof. As such, the network may include any number of additional devices, such as additional computers, routers, and switches, to facilitate communications. In some embodiments, the network may be or include a single network, and in other embodiments the network may be or include a collection of networks.

The devices of the invention provide a bridge between any kinesthetic haptic hardware and the XR visualization such that the immersive experience represents seamless, real-world interactions, for example, interactions such as the user interacting with a patient's tissue; and manipulating surgical tools or equipment. As disclosed herein, the simulation platform integrates the data from the haptic engine and the simulation engine to synchronize the haptic feedback with the interaction of the user within the immersive environment.

The simulation platform of the devices of the invention provides a communication layer between the haptic data and the graphic rendering data. The simulation platform integrates the data from the simulation engine with the complex mathematical and physics calculations of the haptic engine and provides only the essential haptic information back to the wearable display such that the simulation represents real-world interactions without perceived latency. The device, via the simulation platform, integrates the information/data from the haptic engine and communicates only the essential information to the wearable display. For example, in some embodiments, only the current states and poses of the haptic simulation are communicated to the wearable display.

The essential data transmitted to the wearable display may include visual simulation data, such as pose and state data. The communication of the essential data to the wearable display may be achieved via a wireless communication protocol. The wireless communication protocol may be any protocol, for example, UDP, Wi-Fi, Bluetooth, Zigbee, Z-Wave, 6LoWPAN, RFID, cellular, LPWAN, NFC, LoRaWAN (Long Range Wide Area Network).

In some embodiments, the wireless communication protocol may be a User Datagram Protocol (UDP) connection. For example communication of the haptic data to the wearable display may be via a direct UDP connection over Wi-Fi, which allows for sending data at a fast rate. Thus the processor of the simulation platform may be configured to transmit to the wearable display, via the wireless connection, one or more signals comprising visual simulation data to be rendered and visually presented to the user.

UDP is a communications protocol primarily used to establish low-latency and loss-tolerating connections between applications. UDP speeds up transmissions because it uses a simple transmission model that doesn't include handshake dialogues to provide reliability, ordering or data integrity. Consequently, UDP may have an unreliable service. To promote lossless data transmission, the systems of the invention may be configured to manage the process of retransmitting lost packets and to correctly arrange received packets. Forward error-correction techniques may be used to improve simulation quality despite some loss. For example, devices of the invention provide for sending complete data in each frame. In this way, even if one packet is lost, it is possible to recover on the next frame. To ensure a minimum latency between the haptic device and the haptic simulation, no haptic information is communicated to the wearable device. Thus, in some embodiments, the visual simulation data comprises required data for visual simulation, wherein the required data for visual simulation is transmitted to the wearable display in each frame of the data transmission.

The devices of the invention provide a novel way of integrating and synchronizing the highly precise and computationally expensive haptic simulation with the immersivity, freedom, and high-quality rendering of a standalone wearable display, without the high cost of a high-spec computer.

The standalone wearable display may be any wearable display, as the devices of the invention are hardware agnostic and may be used with any wearable display. The device is operable to run on wearable displays having different operating systems. For example, the wearable display may be a VR headset such as the Apple Vision Pro or the Meta Quest 3. In non-limiting examples, the wearable display may be XR googles, an XR headset, or a VR, AR, or MR display. In some embodiments, the wearable display is an XR headset.

In some embodiments of devices of the invention, data from the one or more wearable displays and data from the one or more haptic devices may be received by the simulation platform. As disclosed herein, the haptic engine may include unique algorithmic processing techniques for creating visual and haptic textures that provide a fully realistic immersive/simulated experience.

The haptic engine may include features that allow for haptics to be updated faster, such as ten times faster, than visuals to provide a realistic interaction with tissue types, for example in surgical simulations. For example, the haptic engine may include a system for defining processing constraints/rules, a compute shader to perform calculations, a collision algorithm, and a system for proprioceptive decoupling and alignment. As disclosed herein, simulation platform and/or the haptic engine may be connected to the haptic device via a wired connection. The haptic engine and/or the simulation platform may be integrated into the haptic device. The device communicates with and exchanges data with one or more haptic devices and one or more wearable displays to provide an associated user with dynamically synchronized haptic feedback and visual feedback based on user interaction with a simulated environment. The haptic information is provided to the display device via a wireless connection.

As disclosed herein, in some embodiments, the simulated environment may include one or more simulated objects. Accordingly, the simulation platform may be configured to monitor actions of the user to identify user interaction with one or more of the simulated objects within the simulated environment based on physical user interaction with the one or more hand-held components, i.e. haptic device.

The simulation platform may include one or more computing systems comprising a storage medium coupled to a processor that causes the processor to generate and provide digital content, as described above. As described in detail herein, the platform may dynamically adjust the generated digital content in response to data (feedback) received from the users and/or devices. The system may capture data from a variety of sensors associated with the user devices, for example, location of the user within the simulated environment, a point of gaze of the user within the simulated environment, a field of view of the user within the simulated environment, as well as a physical setting and objects within the environment. The sensors may include one or more of a camera, motion sensor, and global positioning satellite (GPS) sensor.

As noted, devices of the invention are software and hardware agnostic and may be configured to interact without limitation with devices that may be embodied as a computer, a desktop computer, a personal computer (PC), a tablet computer, a laptop computer, a notebook computer, a mobile computing device, a smart phone, a cellular telephone, a handset, a messaging device, a work station, a distributed computing system, a multiprocessor system, a processor-based system, and/or any other computing device configured to store and access data, and/or to execute software and related applications consistent with the present disclosure.

The device provides a user interface or dashboard with which a user and/or administrators, such as institution managers, may interact. For example, the device may include a web portal with which the user may interact with the dashboard/system via a mobile device, tablet, and/or desktop computer, such that the user interface may be embodied as a web application.

The devices of the present disclosure may include, in some embodiments, computer systems, computer operated methods, computer products, systems including computer-readable memory, systems including a processor and a tangible, non-transitory memory configured to communicate with the processor, the tangible, non-transitory memory having stored instructions that, in response to execution by the processor, cause the system to perform steps in accordance with the disclosed principles, systems including non-transitory computer-readable storage medium configured to store instructions that when executed cause a processor to follow a process in accordance with the disclosed principles, etc.

The processor(s) may be operably connected to the communication infrastructure and system architecture. The processor may be embodied as a single or multi-core processor(s), digital signal processor, microcontroller, or other processor or processing/controlling circuit.

The computing system further includes memory, such as random access memory (RAM), and may also include secondary memory. The memory may be embodied as any type of device or devices configured for short-term or long-term storage of data such as, for example, memory devices and circuits, memory cards, hard disk drives, solid-state drives, or other data storage devices. Similarly, the memory may be embodied as any type of volatile or non-volatile memory or data storage capable of performing the functions described herein.

Devices of the invention may include and/or utilize one or more databases. In view of the disclosure provided herein, those of skill in the art will recognize that many databases are suitable for storage and retrieval of baseline datasets, files, file systems, objects, systems of objects, as well as data structures and other types of information described herein. In various embodiments, suitable databases include, by way of non-limiting examples, relational databases, non-relational databases, object oriented databases, object databases, entity-relationship model databases, associative databases, and XML databases. Further non-limiting examples include SQL, PostgreSQL, MySQL, Oracle, DB2, and Sybase. In some embodiments, a database may be internet-based. In further embodiments, a database may be web-based. In still further embodiments, a database may be cloud computing-based. In other embodiments, a database may be based on one or more local computer storage devices.

### Methods for Synchronizing Haptic-Visual Simulation Data

Aspects of the invention provide methods for providing an extended reality (XR) simulation.

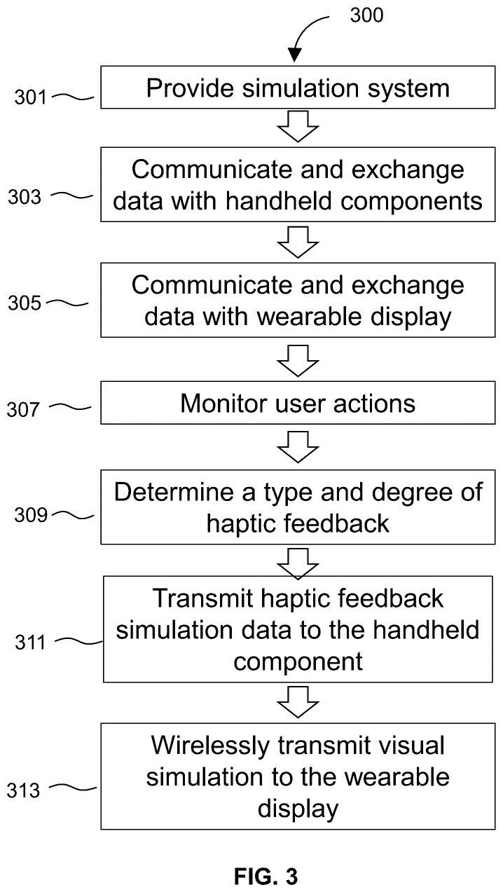

FIG. 3 illustrates a block diagram of a method 300 for providing an XR simulation according to one embodiment of the invention. The method 300 includes providing 301 a system comprising a simulation platform configured to communicate and exchange data with one or more hand-held components and a wearable display for respectively providing an associated user with dynamically synchronized haptic feedback and visual feedback based on user interaction with a simulated environment. Further, the method includes communicating and exchanging data 303 with the one or more hand-held components via a wired connection, and communicate and exchange data 305 with the wearable display via a wireless connection. In some embodiments, the simulated environment includes one or more simulated objects. The method includes monitoring 307 actions of the user to identify user interaction with one or more simulated objects within the simulated environment based on physical user interaction with the one or more hand-held components.

In some embodiments, the simulation platform comprises a hardware processor coupled to non-transitory, computer-readable memory encoded with a computer program that causes the processor to determine 309 a type and a degree of haptic feedback to be provided to the user via the one or more hand-held components based on the user's physical interaction with the one or more hand-held components and the type of one or more simulated objects interacted with. Further, the method includes transmitting 311, via the processor, one or more signals, via the wired connection, comprising haptic feedback simulation data to the one or more hand-held components to thereby cause the one or more hand-held components to provide the determined haptic feedback to the user. In some embodiments, the measured latency of transmission of the haptic feedback simulation data to the one or more hand-held components is less than 1 milliseconds. In some embodiments, the haptic feedback provided to the user via the one or more hand-held components and associated visual feedback provided to the user via the wearable display have a latency of less than 1 milliseconds.

In some embodiments, the simulation platform comprises a hardware processor coupled to non-transitory, computer-readable memory encoded with a computer program that causes the processor to adjust output of digital content to be visually presented to the user via the wearable display based, at least in part, on the user's physical interaction with the one or more hand-held components. In some embodiment of the method, the processor is configured to transmit 313 one or more signals, via the wireless connection, comprising visual simulation data to the wearable display to be rendered and visually presented to the user.

In some embodiments, the rendered visual digital content presented to the user via the wearable display mimics movement of the one or more simulated objects interacted with and based on the user's physical interaction with the one or more hand-held objects. In some embodiments, the simulation platform further comprises a simulation engine configured to model the interactions using calculations associated with one or more algorithms comprising at least one of a position-based solver, a collision detection algorithm, a deformable mesh algorithm, and an adaptive mesh algorithm.

Thus, the invention includes methods for providing an immersive simulation experience. For example, aspects of the invention provide methods for providing an extended reality (XR) simulation. The simulation may be any simulated environment. In non-limiting examples, the simulation may be one or more of an extended reality (XR), a virtual reality (VR), a mixed reality (MR), an augmented reality (AR), a cross reality, a cinematic virtual reality, and/or a spatial computing environment. The methods of the invention may be use an integrated platform that combines visual, audible and haptic capabilities in an immersive XR environment for teaching and assessing skills, with particular focus on precision skills transfer.

The methods described herein are configured to provide a realistic immersive experience that includes a realistic level of visual, and/or auditory, and kinesthetic/tactile data (detail) that is presented without processing delay such that the interaction is seamless to the user. The architecture of systems of the methods include a simulation platform, which may include a haptic engine and a simulation engine. The simulation platform is configured to communicate and exchange data with one or more hand-held components, i.e. haptic device, and one or more wearable displays, i.e. an XR headset, for respectively providing an associated user with dynamically synchronized haptic feedback and visual feedback based on user interaction with a simulated environment.

The simulation platform may include a haptic engine that uses an algorithmic approach to haptic tool action and programming, allowing for rapid development of tool/object haptic interaction. As used herein, a haptic tool may be any simulated object that can affect a haptic response on a secondary simulated item (haptic target). The haptic target may be any simulated item that can be affected by a haptic tool. A haptic action may be the interaction between a haptic tool and a haptic target, often when a force is applied.

Haptic systems may provide both kinesthetic feedback, i.e. feedback simulating the weight or pressure of an object, or tactile feedback which simulates texture. The haptic simulation is processed using the haptic engine 103, which is provided on a separate computing device than the simulation engine. For example, the haptic simulation may be processed on a low-spec and compact form factor computer such as a Raspberry PI. By low-spec, the computer may be an economical computer, for example a non-gaming computer without a dedicated graphics card. The haptic engine may be connected to the haptic device, in some embodiments, for example via a wired or wireless connection. Alternatively, the haptic engine may be embedded into the haptic device. Thus, systems of the methods may include providing the haptic engine on a separate computing device connected to the haptic device and/or embedded into the haptic device.

By providing the haptic engine on a separate computing device, the simulation platform calculates the haptic simulation at a high frame rate and a low latency between the haptic engine and the haptic device. For example, the latency between transmission of the haptic feedback simulation from the simulation platform to the haptic device may be less than 6 milliseconds. In some embodiments, the measured latency of transmission of the haptic feedback simulation data to the one or more hand-held components may be less than 1 milliseconds. In some embodiments, the haptic feedback provided to the user via the one or more hand-held components and associated visual feedback provided to the user via the wearable display have a latency of less than 1 milliseconds.

In some embodiments, the simulation platform may be configured to communicate and exchange data with the one or more hand-held components via a wired connection, and to communicate and exchange data with the wearable display via a wireless connection. Thus, in some embodiments, the haptic engine may be connected to the haptic device through a wired connection, such as via a USB connection. In some embodiments, the haptic engine may be integrated into the haptic device as part of the haptic device.

In some embodiments, the simulation platform includes a hardware processor coupled to non-transitory, computer-readable memory encoded with a computer program that causes the processor to determine a type and a degree of haptic feedback to be provided to the user via the one or more hand-held components based on the user's physical interaction with the one or more hand-held components and the type of one or more simulated objects interacted with. In some embodiments, the processor is configured to transmit one or more signals, via the wired connection, comprising haptic feedback simulation data to the one or more hand-held components to thereby cause the one or more hand-held components to provide the determined haptic feedback to the user.

The methods, via the simulation platform and/or haptic engine, may perform the complex mathematical and physics calculations to generate the haptic simulation. For example, the method may use algorithmic calculations to determine a type and degree of haptic feedback, i.e. a haptic value, based on properties of the simulated object and the haptic tool. This haptic value may be used to transmit haptic feedback to the hand-held device. Thus, the methods of the invention do not specifically program the combination of each type of interaction on a case-by-case basis, and are not limited to pre-determined interactions. A simulated object may be displayed and the movement of the haptic tool may be moved based on a user's movement of a hand-held device. Moreover, the visual feedback may also be algorithmically configured to be displayed in accordance with the type of interaction. This approach to achieving unique, free-form interactions of each haptic tool with haptic targets such as tissues or substances is made possible by defining a limited number of possible affordances that a haptic tool can implement along with a matching number of possible susceptibilities that a haptic target can respond to. These affordances and susceptibilities are each assigned a numerical value which are then combined to establish the nature of the interaction between the haptic tools and haptic targets.

For example, tools may have a defined sharpness affordance and targets may have a defined sharpness susceptibility, such that these values may be combined algorithmically and translated into actions and effects in the simulation. This creates an abstraction layer between a tool and its affordances, and a target and its susceptibilities, which enables the systematic and generalizable calculation of effects generated. As a result, complexity and effort are proportional to the number of affordances and susceptibilities of the tools and targets of the simulation, which allows the systems of the invention to store data related to the virtual/augmented/cross-reality experience in a highly efficient manner. This allows for the handling of interactions between tools and targets to be conducted through an abstraction layer, which radically reduces the amount of programming effort needed to support the required tools and targets needed to fulfil the simulation.

Further, methods of the invention may utilize high frequency haptic surface data, a mechanism for creating high volumes of haptic information via the use of 2-dimensional (2D) UV coordinates. The standard approach to defining the shape of an object in 3D simulations using haptics is use polygons as an easily computable approximation. By definition these polygons are flat and contain no surface detail of any kind. In order to increase the level of detail of the haptic shape it is necessary to increase the number of polygons and consequently the load on the processor in terms of vertex data processing and collision detection. Humans may be able to detect variation in surface texture with sub micro-meter accuracy. As a result, modelling objects in the simulation at this level of detail quickly reaches a limit above which an acceptable frame-rate cannot be maintained and is therefore not possible to deliver precise haptic reactions at a small scale using standard techniques.

Methods of the invention may add haptic detail to the flat surface of polygons via a two dimensional array of height offsets which can be easily authored as a grey-scale image using commonly available graphics tools. In standard graphics engines, polygons are defined by vertices. Each vertex contains its position in 3D space along with storage space for a two dimensional coordinate, referencing a point within an image, otherwise known as UV coordinates. With visual rendering the UV coordinates are used to enhance the appearance of the surface of the object.

The methods of the invention are configured to communicate with and interface with one or more haptic devices. The haptic device may be any haptic device. Methods of the invention may interface with, for example, force-based haptic devices, thermal based haptic devices, and nerve stimulation based haptic devices. The haptic device may be a hand-based device such as a glove or hand-held component, or wearable devices, such as fingertip, glove-based or exoskeleton devices, or handheld and/or tool-based devices. In non-limiting examples, the handheld component may be a wand, joystick, haptic glove, grasper, mouse or roller. In some embodiments, the one or more handheld components is kinesthetic haptic hardware.

The simulation platform communicates with the one or more haptic feedback devices through the manufacturer's API. The interface of the API may be adapted by the system so that communication with the simulation platform, and/or haptic engine, can take place. This allows for any haptic device to be connected to the systems of the invention. The system may be configured to run different operating systems and is capable of integrating with devices with different hardware requirements. Thus, the methods of the invention are device agnostic for both the haptic devices and the wearable displays.

The methods of the invention, via the algorithmic and physics calculations performed by the haptic engine and used to generate a haptic response, may simulate the complex multi-modal haptic stimuli experienced in the physical world by integrating kinesthetic and tactile perception with the visual immersive environment. Tactile perception relies on cutaneous receptors in the skin that perceive mechanical stimuli, such as high/low frequency vibrations, pressure and shear deformation, as well as electrical stimuli, temperature and chemicals. Cutaneous, or fingertip, haptic interfaces stimulate the user's skin at the fingertip to emulate the sensation of touching a real object by stimulating RA, SA1, and SA2 type mechanoreceptors. Kinesthetic haptic interfaces provide feedback in the form of force sensations that stimulate both mechanical stimuli as well as stimuli related to the position and movement of the body. Kinesthetic perception relies on sensory receptors in muscles, tendons, and joints that reflect the operational state of the human locomotor system, such as joint positions, limb alignment, body orientation and muscle tension. The methods of the invention support both cutaneous and kinesthetic haptics, in the form of multiple handheld devices and gloves. To recreate these extensive haptic experiences in a virtual setting requires complex technological solutions provided by systems of the invention.

In some embodiments, the simulation platform may include a simulation engine. The simulation engine may include the digital content, information, and data for application execution and graphics processing for visually rendering the simulated immersive environment. The simulation engine may manage the 3D data and provide for rendering and texturing models, and loading and rendering the data to the wearable display. In some embodiments, the simulation engine is configured to model the interactions using calculations associated with one or more algorithms comprising at least one of a position-based solver, a collision detection algorithm, a deformable mesh algorithm, and an adaptive mesh algorithm.

The simulation engine may be provided on a same or separate computing device than the haptics engine. In some embodiments, the simulation platform comprises a hardware processor coupled to non-transitory, computer-readable memory encoded with a computer program that causes the processor to adjust output of digital content to be visually presented to the user via the wearable display based, at least in part, on the user's physical interaction with the one or more hand-held components. In some embodiments, the processor is configured to transmit one or more signals, via the wireless connection, comprising visual simulation data to the wearable display to be rendered and visually presented to the user. In some embodiments, the rendered visual digital content presented to the user via the wearable display mimics movement of the one or more simulated objects interacted with and based on the user's physical interaction with the one or more hand-held objects.

The systems of the methods may be a web-based network server or web-based procedure platform. The simulation platform may be embodied on an internet-based computing system/service, such as a cloud based service. The system architecture of methods of the invention may be multi-tenant. The system and/or the simulation platform may be embodied on an internet-based computing system/service. The system architecture backend may be a cloud based service. The network may represent, for example, a private or non-private local area network (LAN), personal area network (PAN), storage area network (SAN), backbone network, global area network (GAN), wide area network (WAN), or collection of any such computer networks such as an intranet, extranet or the Internet (i.e., a global system of interconnected network upon which various applications or service run including, for example, the World Wide Web). In alternative embodiments, the communication path between the simulation platform and/or the handheld components, wearable displays, and the cloud-based service, may be, in whole or in part, a wired connection.

The network may be any network that carries data. Non-limiting examples of suitable networks that may be used as network include Wi-Fi wireless data communication technology, the internet, private networks, virtual private networks (VPN), public switch telephone networks (PSTN), integrated services digital networks (ISDN), digital subscriber link networks (DSL), various second generation (2G), third generation (3G), fourth generation (4G) cellular-based data communication technologies, fifth generation (5G) cellular-based data communication technologies, Bluetooth radio, Near Field Communication (NFC), the most recently published versions of IEEE 802.11 transmission protocol standards as of October 2018, other networks capable of carrying data, and combinations thereof. In some embodiments, network may be chosen from the internet, at least one wireless network, at least one cellular telephone network, and combinations thereof. As such, the network may include any number of additional devices, such as additional computers, routers, and switches, to facilitate communications. In some embodiments, the network may be or include a single network, and in other embodiments the network may be or include a collection of networks.

The methods of the invention provide a bridge between any kinesthetic haptic hardware and the XR visualization such that the immersive experience represents seamless, real-world interactions, for example, interactions such as the user interacting with a patient's tissue; and manipulating surgical tools or equipment. As disclosed herein, the simulation platform integrates the data from the haptic engine and the simulation engine to synchronize the haptic feedback with the interaction of the user within the immersive environment.

The simulation platform provides a communication layer between the haptic data and the graphic rendering data. The simulation platform integrates the data from the simulation engine with the complex mathematical and physics calculations of the haptic engine and provides only the essential haptic information back to the wearable display such that the simulation represents real-world interactions without perceived latency. The methods, via the simulation platform, integrates the information/data from the haptic engine and communicates only the essential information to the wearable display. For example, in some embodiments, only the current states and poses of the simulation are communicated to the wearable display.

The essential data transmitted to the wearable display may include visual simulation data, such as pose and state data. The communication of the essential data to the wearable display may be achieved via a wireless communication protocol. The wireless communication protocol may be any protocol, for example, UDP, Wi-Fi, Bluetooth, Zigbee, Z-Wave, 6LoWPAN, RFID, cellular, LPWAN, NFC, LoRaWAN (Long Range Wide Area Network).

In some embodiments, the wireless communication protocol may be a User Datagram Protocol (UDP) connection. For example communication of the haptic data to the wearable display may be via a direct UDP connection over Wi-Fi, which allows for sending data at a fast rate. Thus the processor of the simulation platform may be configured to transmit to the wearable display, via the wireless connection, one or more signals comprising visual simulation data to be rendered and visually presented to the user.

UDP is a communications protocol primarily used to establish low-latency and loss-tolerating connections between applications. UDP speeds up transmissions because it uses a simple transmission model that doesn't include handshake dialogues to provide reliability, ordering or data integrity. Consequently, UDP may have an unreliable service. To promote lossless data transmission, the systems of the invention may be configured to manage the process of retransmitting lost packets and to correctly arrange received packets. Forward error-correction techniques may be used to improve simulation quality despite some loss. For example, systems of the invention provide for sending complete data in each frame. In this way, even if one packet is lost, it is possible to recover on the next frame. To ensure a minimum latency between the haptic device and the haptic simulation, no haptic information is communicated to the wearable device. Thus, in some embodiments, the visual simulation data comprises required data for visual simulation, wherein the required data for visual simulation is transmitted to the wearable display in each frame of the data transmission.

The methods of the invention provide a novel way of integrating and synchronizing the highly precise and computationally expensive haptic simulation with the immersivity, freedom, and high-quality rendering of a standalone wearable display, without the high cost of a high-spec computer.

The standalone wearable display may be any wearable display, as the systems of the invention are hardware agnostic and may be used with any wearable display. The methods are operable to run the system on wearable displays having different operating systems. For example, the wearable display may be a VR headset such as the Apple Vision Pro or the Meta Quest 3. In non-limiting examples, the wearable display may be XR googles, an XR headset, or a VR, AR, or MR display. In some embodiments, the wearable display is an XR headset.

Further, methods of the invention may use performant rendering of interior volumes of multi-part solids for seamless representation of dynamic object interaction and structures. Simulations must calculate and represent visual properties in milliseconds based on the user's actions. The methods of the invention may combine a voxel representation with a the use of texture atlasing, enabling significant improvement in performance and efficiency. The result is the seamless representation of dynamic object interaction with structures made up of many different textures and tissues, that is hardware agnostic.

Methods of the invention may use texture atlasing to tri-planar mapping, an approach to modelling 3-dimensional (3D) visual graphics which results in higher fidelity and lower latency of visual elements. Within the domain of 3D computer graphics, tri-planar visual texture mapping is the conventional way to texture the meshes created by various adaptive mesh algorithms (marching cubes/tetrahedrons etc.). It creates a near seamless surface by applying a texture using coordinates projected along three axes and blending them according to the vertex normals. However, representation of multiple material types is not well supported using this method, often leaving a less than ideal visual representation or a downturn in rendering speed, such that, as the user penetrates the virtual object, each visual effect needs to be programmed and rendered into the space. This results in a significant increase in code complexity and requires the creation of multiple meshes which in turn require multiple draw calls to be made, increasing processor load.

Methods of the invention are configured to represent multiple material types by using the otherwise unused texture coordinates (also known as UV coordinates) to represent an offset into a texture atlas comprised of multiple surface textures to depict various materials. Hence, unused UV coordinates are repurposed to refer to a texture atlas comprising the various material types, thereby providing an efficient and streamlined method of applying textures to a virtual object in real-time. For example, UV coordinates associated with voxels of a virtual object may be identified and then used to locate textures within the texture atlas using offset values based on the UV coordinates. Once located, the textures may be mapped onto the voxels of the virtual object. This provides a solution to the technical problem of generating a virtual environment with virtual objects that have multiple textures in real-time.

As disclosed herein, the haptic engine may include unique algorithmic processing techniques for creating visual and haptic textures that provide a fully realistic immersive/simulated experience. The haptic engine may include features that allow for haptics to be updated faster, such as ten times faster, than visuals to provide a realistic interaction with tissue types, for example in surgical simulations. For example, the haptic engine may include a system for defining processing constraints/rules, a compute shader to perform calculations, a collision algorithm, and a system for proprioceptive decoupling and alignment. As disclosed herein, the simulation engine and/or the haptic engine may be connected to the haptic device via a wired connection. The haptic engine and/or the simulation platform may be integrated into the haptic device. The system communicates with and exchanges data with one or more haptic devices and one or more wearable displays to provide an associated user with dynamically synchronized haptic feedback and visual feedback based on user interaction with a simulated environment. The haptic information is provided to the display device via a wireless connection.

The simulation platform may include one or more computing systems comprising a storage medium coupled to a processor that causes the processor to generate and provide digital content, as described above. As described herein, the simulation platform may dynamically adjust the generated digital content in response to data (feedback) received from the users and/or devices. The system may capture data from a variety of sensors associated with the user devices, for example, location of the user within the simulated environment, a point of gaze of the user within the simulated environment, a field of view of the user within the simulated environment, as well as a physical setting and objects within the environment. The sensors may include one or more of a camera, motion sensor, and global positioning satellite (GPS) sensor.

As noted, methods of the invention are software and hardware agnostic and the platform may be configured to interact without limitation with devices that may be embodied as a computer, a desktop computer, a personal computer (PC), a tablet computer, a laptop computer, a notebook computer, a mobile computing device, a smart phone, a cellular telephone, a handset, a messaging device, a work station, a distributed computing system, a multiprocessor system, a processor-based system, and/or any other computing device configured to store and access data, and/or to execute software and related applications consistent with the present disclosure.

The system may include a user interface or dashboard with which a user may interact. Users may interact with the user interface/dashboard via an associated device. For example, the system may include a web portal with which the user may interact with the dashboard/system via a mobile device, tablet, and/or desktop computer, such that the user interface may be embodied as a web application.

The systems of methods may include, in some embodiments, computer systems, computer operated methods, computer products, systems including computer-readable memory, systems including a processor and a tangible, non-transitory memory configured to communicate with the processor, the tangible, non-transitory memory having stored instructions that, in response to execution by the processor, cause the system to perform steps in accordance with the disclosed principles, systems including non-transitory computer-readable storage medium configured to store instructions that when executed cause a processor to follow a process in accordance with the disclosed principles, etc.

The processor(s) may be operably connected to the communication infrastructure and system architecture. The processor may be embodied as a single or multi-core processor(s), digital signal processor, microcontroller, or other processor or processing/controlling circuit.

The computing system further includes memory, such as random access memory (RAM), and may also include secondary memory. The memory may be embodied as any type of device or devices configured for short-term or long-term storage of data such as, for example, memory devices and circuits, memory cards, hard disk drives, solid-state drives, or other data storage devices. Similarly, the memory may be embodied as any type of volatile or non-volatile memory or data storage capable of performing the functions described herein.

Methods of the invention include and/or utilize one or more databases. In view of the disclosure provided herein, those of skill in the art will recognize that many databases are suitable for storage and retrieval of baseline datasets, files, file systems, objects, systems of objects, as well as data structures and other types of information described herein. In various embodiments, suitable databases include, by way of non-limiting examples, relational databases, non-relational databases, object oriented databases, object databases, entity-relationship model databases, associative databases, and XML databases. Further non-limiting examples include SQL, PostgreSQL, MySQL, Oracle, DB2, and Sybase. In some embodiments, a database may be internet-based. In further embodiments, a database may be web-based. In still further embodiments, a database may be cloud computing-based. In other embodiments, a database may be based on one or more local computer storage devices.

Systems of the invention may include modules and submodules, for example, a data collection and management module, digital content creation, management, and distribution module, and various databases for storage of data, such as a user database for storing profiles and data of users and/or their associated devices. A data collection and management module may be configured to communicate and exchange data with each of the databases, as well as the other aspects/modules of the system.

As used in any embodiment herein, the term “module” may refer to software, firmware and/or circuitry configured to perform any of the aforementioned operations. Software may be embodied as a software package, code, instructions, instruction sets and/or data recorded on non-transitory computer readable storage medium. Firmware may be embodied as code, instructions or instruction sets and/or data that are hard-coded (e.g., nonvolatile) in memory devices.

“Circuitry”, as used in any embodiment herein, may comprise, for example, singly or in any combination, hardwired circuitry, programmable circuitry such as computer processors comprising one or more individual instruction processing cores, state machine circuitry, and/or firmware that stores instructions executed by programmable circuitry. The modules may, collectively or individually, be embodied as circuitry that forms part of a larger system, for example, an integrated circuit (IC), system on-chip (SoC), desktop computers, laptop computers, tablet computers, servers, smartphones, etc.

Any of the operations described herein may be implemented in a system that includes one or more storage mediums having stored thereon, individually or in combination, instructions that when executed by one or more processors perform the methods. Here, the processor may include, for example, a server CPU, a mobile device CPU, and/or other programmable circuitry.

Also, it is intended that operations described herein may be distributed across a plurality of physical devices, such as processing structures at more than one different physical location. The storage medium may include any type of tangible medium, for example, any type of disk including hard disks, floppy disks, optical disks, compact disk read-only memories (CD-ROMs), compact disk rewritables (CD-RWs), and magneto-optical disks, semiconductor devices such as read-only memories (ROMs), random access memories (RAMs) such as dynamic and static RAMs, erasable programmable read-only memories (EPROMs), electrically erasable programmable read-only memories (EEPROMs), flash memories, Solid State Disks (SSDs), magnetic or optical cards, or any type of media suitable for storing electronic instructions. Other embodiments may be implemented as software modules executed by a programmable control device. The storage medium may be non-transitory.

As described herein, various embodiments may be implemented using hardware elements, software elements, or any combination thereof. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth.

Reference throughout this specification to “one embodiment” or “an embodiment” means that a particular feature, structure, or characteristic described in connection with the embodiment is included in at least one embodiment. Thus, appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

The term “non-transitory” is to be understood to remove only propagating transitory signals per se from the claim scope and does not relinquish rights to all standard computer-readable media that are not only propagating transitory signals per se. Stated another way, the meaning of the term “non-transitory computer-readable medium” and “non-transitory computer-readable storage medium” should be construed to exclude only those types of transitory computer-readable media which were found in In Re Nuijten to fall outside the scope of patentable subject matter under 35 U.S.C. § 101.

The terms and expressions which have been employed herein are used as terms of description and not of limitation, and there is no intention, in the use of such terms and expressions, of excluding any equivalents of the features shown and described (or portions thereof), and it is recognized that various modifications are possible within the scope of the claims. Accordingly, the claims are intended to cover all such equivalents.

### Incorporation by Reference

References and citations to other documents, such as patents, patent applications, patent publications, journals, books, papers, web contents, have been made throughout this disclosure. All such documents are hereby incorporated herein by reference in their entirety for all purposes.

### Equivalents

Various modifications of the invention and many further embodiments thereof, in addition to those shown and described herein, will become apparent to those skilled in the art from the full contents of this document, including references to the scientific and patent literature cited herein. The subject matter herein contains important information, exemplification and guidance that can be adapted to the practice of this invention in its various embodiments and equivalents thereof.

1. A system for providing an extended reality (XR) simulation, the system comprising a simulation platform configured to communicate and exchange data with one or more hand-held components and a wearable display for respectively providing an associated user with dynamically synchronized haptic feedback and visual feedback based on user interaction with a simulated environment.

2. The system of claim 1, wherein the simulation platform is configured to:
communicate and exchange data with the one or more hand-held components via a wired connection; and
communicate and exchange data with the wearable display via a wireless connection.

3. The system of claim 2, wherein the simulated environment comprises one or more simulated objects.

4. The system of claim 3, wherein the simulation platform is configured to monitor actions of the user to identify user interaction with one or more simulated objects within the simulated environment based on physical user interaction with the one or more hand-held components.

5. The system of claim 4, wherein the simulation platform comprises a hardware processor coupled to non-transitory, computer-readable memory encoded with a computer program that causes the processor to determine a type and a degree of haptic feedback to be provided to the user via the one or more hand-held components based on the user's physical interaction with the one or more hand-held components and the type of one or more simulated objects interacted with.

6. The system of claim 5, wherein the processor is configured to transmit one or more signals, via the wired connection, comprising haptic feedback simulation data to the one or more hand-held components to thereby cause the one or more hand-held components to provide the determined haptic feedback to the user.

7. The system of claim 6, wherein a measured latency of transmission of the haptic feedback simulation data to the one or more hand-held components is 1 millisecond or less.

8. The system of claim 7, wherein haptic feedback provided to the user via the one or more hand-held components and associated visual feedback provided to the user via the wearable display have a latency of 1 millisecond or less.

9. The system of claim 3, wherein the simulation platform comprises a hardware processor coupled to non-transitory, computer-readable memory encoded with a computer program that causes the processor to adjust output of digital content to be visually presented to the user via the wearable display based, at least in part, on the user's physical interaction with the one or more hand-held components.

10. The system of claim 9, wherein the processor is configured to transmit one or more signals, via the wireless connection, comprising visual simulation data to the wearable display to be rendered and visually presented to the user.

11. The system of claim 10, wherein the rendered visual digital content presented to the user via the wearable display mimics movement of the one or more simulated objects interacted with and based on the user's physical interaction with the one or more hand-held objects.

12. The system of claim 11, wherein the simulation platform further comprises a simulation engine configured to model the interactions using calculations associated with one or more algorithms comprising at least one of a position-based solver, a collision detection algorithm, a deformable mesh algorithm, and an adaptive mesh algorithm.

13. The system of claim 10, wherein the visual simulation data is transmitted to the wearable display via a wireless communication protocol.

14. The system of claim 13, wherein the wireless communication protocol is a User Datagram Protocol (UDP) connection.

15. The system of claim 13, wherein the visual simulation data comprises required data for visual simulation, wherein the required data for visual simulation is transmitted to the wearable display in each frame of the data transmission.

16. The system of claim 1, wherein the one or more hand-held components comprise kinesthetic haptic hardware.

17. The system of claim 1, wherein the wearable display comprises an XR headset.

18. The system of claim 1, wherein the system is operable to run on wearable displays having different operating systems.
